(19) United States
(12) Patent Application Publication
(10) Pub. No.: US 2024/0369413 A1
(43) Pub. Date: Nov. 7, 2024

(54) METHOD AND APPARATUS FOR INSPECTING SURFACES

(71) Applicant: BYK-GARDNER GMBH, Geretsried (DE)

(72) Inventor: Uwe SPERLING, Geretsried (DE)

(21) Appl. No.: 18/561,765

(22) PCT Filed: May 18, 2022
(86) PCT No.: PCT/EP2022/063483

§ 371 Date: Nov. 17, 2023

(30) Foreign Application Priority Data
May 21, 2021 (DE) 10 2021 113 233.9

(51) Int. Cl. G01J 3/46; G01J 3/50

(52) U.S. Cl. CPC G01J 3/465; G01J 3/504

(57) ABSTRACT

A method for inspecting surfaces is provided and in particular surfaces of motor vehicles having effect pigments, wherein radiation is irradiated by means of a first radiation device onto a surface to be inspected at a first predetermined radiation angle and wherein a color image recording device records a spatially resolved image of the surface irradiated by the radiation direction at a first observation angle, wherein this image recording device has a first predetermined sensitivity (F(λ)) which is dependent on a wavelength of the radiation impinging the image recording device and which differs from a second predetermined sensitivity (X(λ)) which is dependent on a wavelength of the radiation impinging on the human eye, characterized in that differences between the first sensitivity (F(λ)) and the second sensitivity (X(λ)) are at least partially compensated for by means of a filter device.

### CROSS-REFERENCE TO RELATED APPLICATIONS

This application claims priority to PCT Application No. PCT/EP2022/063483, having a filing date of May 18, 2022, based on German Application No. 10 2021 113 233.9, having a filing date of May 21, 2021, the entire contents both of which are hereby incorporated by reference.

### FIELD OF TECHNOLOGY

The following relates to a method and an apparatus for examining surface properties. The following is described with reference to vehicle surfaces, but it is noted that the apparatus may also have application to other surfaces, such as furniture.

### BACKGROUND

Coatings with effect pigments have been known in the state of the conventional art for some time. These have different optical properties depending on the viewing angle. A wide variety of inspection devices for inspecting such surfaces are also known. Such an inspection can be carried out, for example, to produce lacquers for damaged surfaces.

For this reason, there is a need for inspection procedures and inspection apparatuses that enable a standardized evaluation of such surfaces.

### SUMMARY

An aspect relates to enabling the most accurate possible evaluation of surfaces. In particular, the observation characteristics of the human eye are to be taken into account. In particular, a realistic color impression of the surfaces to be examined should also be made possible.

In a method according to embodiments of the invention for inspecting surfaces and in particular surfaces of motor vehicles which have effect pigments, radiation is irradiated by means of a first radiation device onto a surface to be inspected at a first predetermined radiation angle, and a color image recording device records a spatially resolved image of the surface irradiated by the radiation direction at a first observation angle, wherein said image recording device having a first predetermined sensitivity depending on a wavelength of the radiation impinging on the image recording device, which sensitivity differs from a second predetermined sensitivity (of the human eye) depending on a wavelength of the radiation impinging on the human eve.

According to embodiments of the invention, differences between the first sensitivity and the second sensitivity are at least partially compensated by means of a filter device. When observing surfaces, the problem arises that commercially available image recording devices such as RGB cameras have a certain wavelength-dependent sensitivity, which deviates from the wavelength-dependent sensitivity of the human eye. Accordingly, the object is to enable the most realistic possible image recording of the irradiated surface (or the most realistic possible evaluation of this image recording).

Embodiments of the invention therefore proposes to achieve, by means of a filter device, an at least partial adaptation of the image recording device to the human eye.

The CIE Standard Valence System or CIE Standard Color System is a color system defined by the International Commission on Illumination (CIE—Commission internationale de l'éclairage) to establish a relationship between human color perception (color) and the physical causes of the color stimulus (color valence). It captures escolo the totality of perceivable colors. Using the color space coordinates, the term Yxy color space or CIE-Yxy is also commonly used, as well as tristimulus color space, primarily in the English-speaking world.

Especially in the English-speaking world, the three basic values X, Y and Z are called tristimulus. In this meaning, they are the three portions of the (for this purpose) defined normalized basic colors. Each color can be identified with such a triple of numbers. Accordingly, the term tristimulus system is commonly used for the CIE standard system. The curves are also called tristimulus curves.

In an embodiment, the filter device is an optical filter device which is arranged in a beam path between the radiation device and the observation device. However, it would also be conceivable that the filter device is a component of an evaluation device which evaluates the images recorded by the image recording device, wherein the filter device can carry out a weighting of the wavelength-dependent sensitivities here and the images recorded by the image evaluation device are weighted pixel by pixel accordingly.

In this embodiment, an image is therefore recorded, and the individual pixels are evaluated, in particular with regard to colors, wherein a wavelength-dependent evaluation and/or weighting is carried out.

In a further method, the filter device influences the evaluation of the image recorded by the image recording device. In an embodiment, the image is evaluated section by section and in particular pixel by pixel. Within the scope of this evaluation, a pixel-by-pixel weighting can be carried out. In particular, the weighting can be carried out as a function of the wavelength of the light incident on the image recording. In an embodiment, different pixels of the recorded image are weighted differently.

It would also be possible for both an optical filter device and a “software” filter device to be used, for example to achieve further improved matching compared to the optical filter device.

In a method, the filter device is arranged between the surface to be examined and the image recording device. In this embodiment, the filter device is therefore an optical element which is integrated into the beam path and through which radiation passes.

In other words, the image recording device observes the surface through the filter device.

This filter device has a wavelength-dependent transmission. The wavelength-dependent transmission has the effect that the light reaching the observation device is already adapted as a function of the wavelength of the light in such a way that the differences between the observation of a human observer, in particular under natural ambient conditions, and the observation device, on the other hand, are at least partially compensated.

In an embodiment, in a wavelength range of 200 nm-1000 nm, the filter device has a transmission that changes in this wavelength range as a function of the wavelength.

The wavelength range is understood to be the wavelength range of radiation irradiated onto the filter device and in particular irradiated light. In an embodiment, the filter device has at least in some areas and continuously a transmission in a wavelength range between 800 nm and 1000 nm, or between 700 nm and 1000 nm, which transmission is below 20% (relative to the irradiated light intensity), below 15%, desirably below 10% and more desirably below 5%.

In an embodiment, the filter device has a transmission in a wavelength range of 200 nm-400 nm, at least in some areas, which is below 20% (related to the irradiated light intensity).

In an embodiment, in a wavelength range of 400 nm-700 nm, the filter device comprises at least one (wavelength) sub-region and at least two wavelength sub-regions with a transmission of more than 80%, desirably more than 85%, desirably more than 90% and desirably more than 95%. In an embodiment, in the wavelength range of 450 nm and 650 nm, the filter device has at least one wavelength sub-region with a transmission of less than 40%, desirably less than 30%, desirably less than 20% and desirably less than 15%.

In an embodiment, in the wavelength range of 400 nm-700 nm, the filter device has both at least one wavelength sub-range with a transmission of more than 80% and at least one wavelength sub-range with a transmission of less than 20%.

In a method, this changing transmission is chosen in such a way that the wavelength-dependent differences between the first sensitivity and the second sensitivity are at least at times compensated.

In this context, an emission spectrum L(λ) of the radiation device, an intensity curve I(λ) of a standard light, at least one tristimulus function X(λ), in particular of the human eye, and/or a value and or curve characteristic of a filter characteristic F(λ) of the image recording device are taken into account when selecting the filter device.

In an embodiment, the wavelength-dependent transmission of the filter device T(λ) results in:

$$T ( λ ) = X ( λ ) / ( I ( λ ) \cdot L ( λ ) \cdot F ( λ ) )$$

Here, I(λ) denotes the wavelength-dependent characteristic of the type of light, for example D65, L(λ) denotes the wavelength-dependent characteristic of the light source, F(λ) denotes the wavelength-dependent characteristic of the observation device (in particular an RGB filter and especially its filter) and X(λ) denotes the wavelength-dependent light receptivity of the eye (tristimulus functions).

In an embodiment, the wavelength-dependent characteristic of the observation device and the wavelength-dependent light sensitivity of the eye have different functions over at least two, desirably 3 predetermined wavelength ranges.

In an embodiment, the first wavelength range extends from 300 nm-00 nm, desirably from 350 nm-550 nm and desirably from 400 nm-500 nm. Furthermore, desirably the second wavelength range extends from 400 nm-700 nm, desirably 450 nm-650 nm, and desirably 500 nm-650 nm and desirably 530 nm-600 nm. Furthermore, the third wavelength range extends from 500 nm-900 nm, desirably from 550 nm-800 nm, and desirably from 600 nm-700 nm.

In doing so, the entire perceptual range of the human eye is covered.

In a further method, the radiation impinging the filter device is influenced and in particular refracted by means of a refractive optical element, which is arranged between the surface and the filter device. In an embodiment, the radiation is diffracted in such a way that it impinges on the filter device in a substantially parallel or collimated manner. In an embodiment, the radiation impinges the filter device perpendicularly.

In a further preferred-method, radiation is irradiated onto the surface at a second predetermined radiation angle by means of a second radiation device and the image recording device records an image of the surface irradiated by the second radiation device.

In an embodiment, the first and second radiation devices irradiate the surface at different times or periods of time. Alternatively, or additionally, it would also be conceivable that a second image recording device observes the surface at a second observation angle.

By irradiating by means of two or more radiation devices, it is also possible to detect effects that result from differently aligned effect pigments.

In a further method, a third radiation device is also provided, which radiates radiation onto the surface at a third radiation angle.

In a further method, the observation angle with respect to a direction perpendicular to the surface is less than 10°, desirably less than 5°, desirably less than 3°.

In a further method, the first radiation angle relative to a direction perpendicular to the surface is between 70° and 20°, desirably between 60° and 30°, desirably between 50° and 40°.

In an embodiment, a second radiation angle of the second radiation device with respect to a direction perpendicular to the surface is between 85° and 50°, desirably between 85° and 60°, desirably is between 85° and 70°.

In an embodiment, at least one radiation device directs directional or diffuse radiation onto the surface. By using diffuse radiation, solar radiation can be simulated under a cloudy sky, and by using directed radiation, solar radiation can be simulated under a cloudless sky.

In an embodiment, at least one further radiation device and all radiation devices direct diffuse or, in particular, directional radiation onto the surface.

Embodiments of the present invention are further directed to an apparatus for inspecting surfaces and in particular surfaces of motor vehicles having effect pigments, comprising a first radiation device which irradiates radiation onto a surface to be inspected at a first predetermined radiation angle and a color image recording device (for example an RGB camera), which takes a spatially resolved image of the surface irradiated by the radiation direction at a first observation angle, wherein this image recording device having a first predetermined sensitivity which is dependent on a wavelength of the radiation impinging on the image recording device and which differs from a second predetermined sensitivity which is dependent on a wavelength of the radiation impinging on the human eye.

According to embodiments of the invention, the apparatus comprises a filter device which at least partially compensates for differences and/or deviations between the first sensitivity and the second sensitivity.

The effect pigments can be, for example, pigments made of TiO₂.

By at least partial compensation it is understood that an average deviation and/or a deviation integrated over a wavelength range from 400 nm to 700 nm is reduced by the use of the filter device and reduced by at least 20%, desirably by at least 40% and desirably by at least 60%.

In an embodiment, the apparatus is a multi-angle measuring device, i.e., it is suitable and intended for inspecting the surface from several (illumination and/or irradiation) angles.

In an embodiment, the apparatus is “backwards” compatible with apparatuses that use a black-and-white image capture device. In particular, measurement results obtained with embodiments of the present invention can be compared with measurement results obtained with black and white imaging recording devices.

However, embodiments of the invention can also be used for basecoats of motor vehicles (or of other surfaces).

Generally, filters absorb unwanted light by adding colored glass or dyes, or they reflect it using interference coatings. Thus, it is possible to use specially designed interference coatings and/or selected materials to achieve a desired transmission profile.

For example, hard-coated optical filters can be used, which have a substrate with dense coatings and excellent optical performance. Traditionally, coated optical filters typically consist of several layers of absorbent materials, interference coatings and metallic layers laminated together to create a low-cost, efficient filter.

Colored glass filters and other absorbing filters such as plastic filters and Wratten filters, contain elements, components, dyes or other coloring agents in the source substrate to influence the spectral properties of the filter.

Optical filter devices can be divided into two main categories: Absorption filters and dichroic filters. The difference between the two variants lies in the type of blocking. With an absorption filter, light is absorbed by the glass used and converted into internal energy, or heat. Absorption filters are ideal for applications where noise from unwanted light is a problem. Absorption filters also have the advantage that blocking is not angle dependent. Light can fall on the filter at a wide range of angles and the filter still retains its transmission and absorption properties.

A dichroic filter device, on the other hand, reflects unwanted wavelengths and allows the desired part of the light spectrum to pass. In this way, both wavelength ranges can be used separately. This is achieved by the coating of the filter. This has one or several thin layers of different materials with different refractive indices. The resulting partial reflections interfere specifically and suppress the reflection or transmission for certain wavelength ranges.

In contrast to absorption filters, dichroic filters are angle-dependent. If light falls on dichroic filters with a different angle of incidence than intended in the design, the effective layer thicknesses change and thus also the design wavelength. For this reason, the above-mentioned lens is used to collimate the light reaching the filter device. In addition, an increasing polarization dependence may result.

In an embodiment, the filter device is an NG (neutral glass) filter, or the filter device also has a neutral glass filter element. In an embodiment, this filter device is arranged in such a way that radiation emanating from the surface impinges it perpendicularly.

In an embodiment, the radiation device and the observation device as well as the filter device are arranged in a common housing. In an embodiment, an inner wall of this housing is light absorbing. In a further embodiment, the housing has essentially only one opening through which the surface is observed. In a further embodiment, the apparatus is portable.

In a further embodiment, the image recording device has filters and in particular RGB filters. In an embodiment, the radiation device emits standard light and in particular D65 standard light. Standard light is the term used to describe the standardized spectral radiation distribution curves of characteristic radiators. D65 standard light is a radiation distribution with a color temperature of 6504 Kelvin (which corresponds approximately to a grey sky).

In a further embodiment, the apparatus has an evaluation device which evaluates images recorded by the image recording device.

In an embodiment, a distance between the surface and the radiation device is between 3 cm and 30 cm, between 4 cm and 20 cm, and between 4 cm and 10 cm.

In an embodiment, the radiation device is suitable and intended to emit radiation of different wavelengths. A filter device such as a filter wheel with different filters can be provided, which only allows light of certain wavelengths to pass.

In a further embodiment, a refractive element and in particular a lens is arranged between the surface (to be inspected) and the filter device. This lens causes the light (scattered by the surface) to impinge the filter essentially collinearly. It is possible that the lens and the filter device are designed as a unit.

In a further embodiment, the first radiation device comprises a light emitting diode (LED) and in particular a tri-phosphor LED. In an embodiment, the apparatus also has further radiation devices, as mentioned above. These also have light-emitting diodes and in particular tri-phosphor LEDs.

In a further embodiment, the apparatus has at least one second radiation device and/or a second sensor device. This second sensor device can also be designed as an image recording device, but it is also conceivable that this sensor device is a sensor device which determines an intensity of the radiation impinging on it.

In a further embodiment, the apparatus has at least three radiation devices (or illumination devices), which illuminate the surface at at least three different angles.

### BRIEF DESCRIPTION

Some of the embodiments will be described in detail, with references to the following Figures, wherein the designations denote like members, wherein:

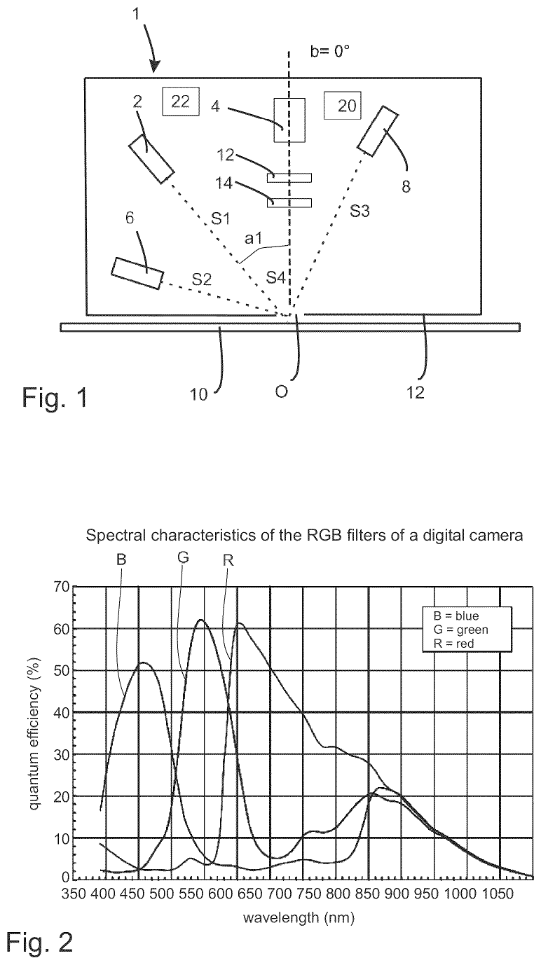

FIG. 1 shows a schematic representation of an apparatus according to embodiments of the invention;

FIG. 2 shows a spectral characteristic of the RGB filters of a digital camera;

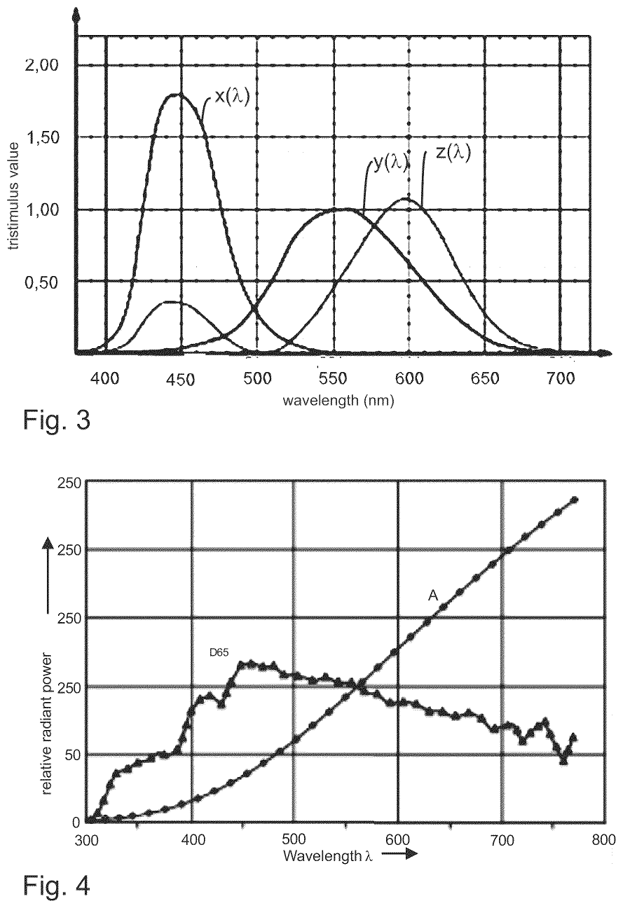

FIG. 3 shows sensitivity curves of the 3 color receptors X (red), Y (green) and Z (blue);

FIG. 4 shows a representation of the radiant power of the standard illuminant D65;

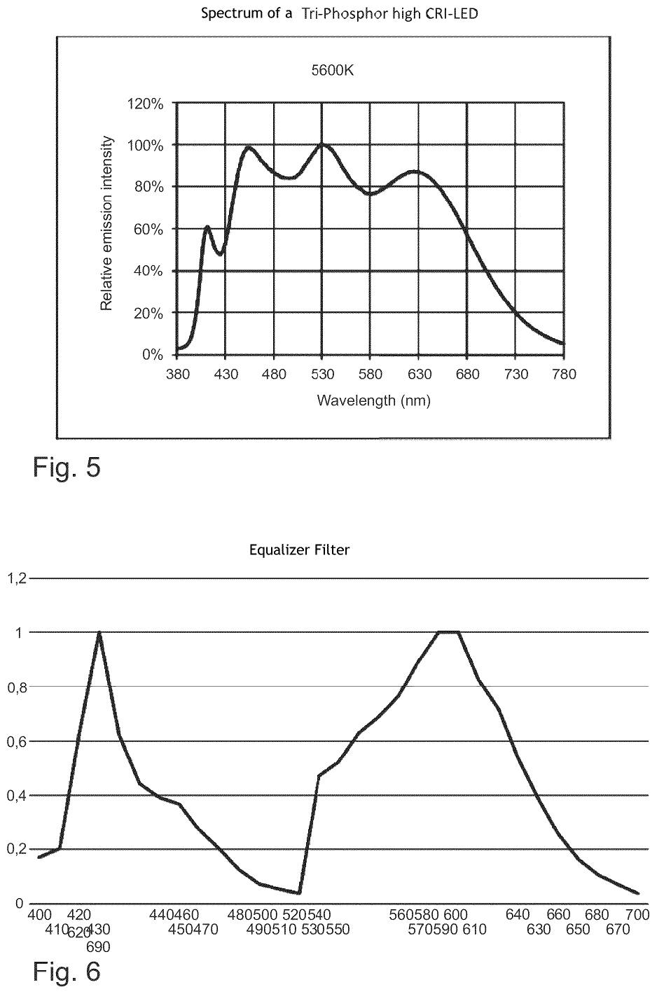

FIG. 5 shows an emission spectrum of an LED;

FIG. 6 shows a transmission be behavior of a filter device;

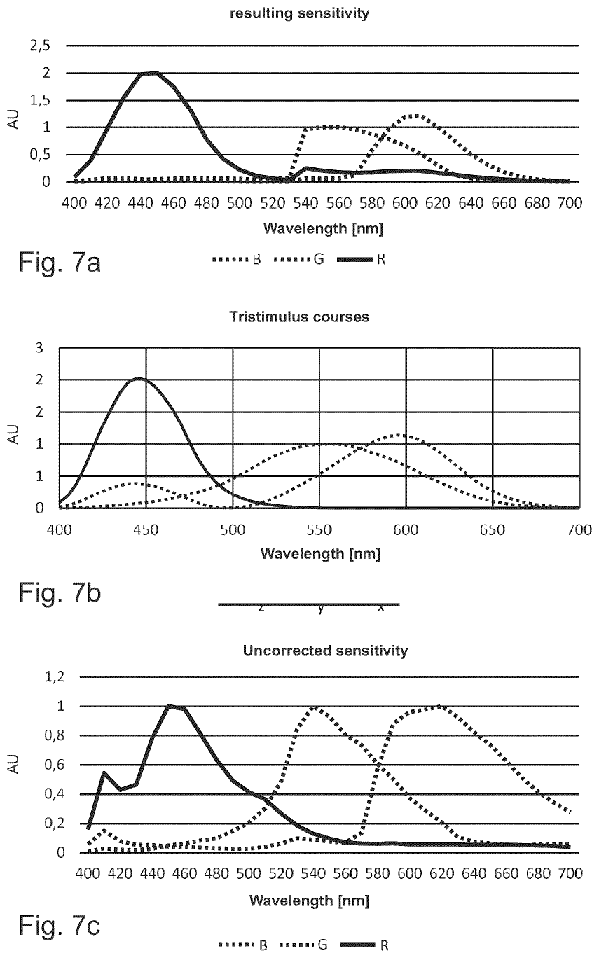

FIG. 7a shows a comparison of the resulting sensitivities;

FIG. 7b shows a comparison of the resulting sensitivities; and

FIG. 7c shows a comparison of the resulting sensitivities.

### DETAILED DESCRIPTION

FIG. 1 shows a schematic representation of an apparatus 1 for inspecting surfaces 10. This apparatus has a first radiation device 2 or illumination device 2 which radiates light onto the surface 10 beam S2.

The reference sign 4 indicates an image recording device which records at least one spatially resolved image of the surface illuminated by the first radiation device (beam path S4). The reference sign O indicates an opening in the housing 12 through which the surface 10 is irradiated and through which the image recording device 4 observes the surface. The image recording device records the images at an observation angle of 0°, i.e., it is arranged vertically above the surface 10.

The reference sign 12 indicates a filter device which is arranged in the beam path S4 between the surface 10 and the image recording device and through which the image recording device records an image of the surface 10.

The reference sign 14 indicates an optionally present lens device which serves to collimate the light reflected and/or scattered by the surface 10 so that it also impinges the filter device in a collimated manner and preferably also perpendicularly to the filter device.

The reference sign 20 indicates an evaluation device which evaluates the images recorded by the image recording device 4. The evaluation device can output data that are characteristic for physical properties of the surface.

The reference sign 6 indicates a second radiation device that also radiates radiation and in particular light onto the surface (but at a different angle of incidence or along the beam path S2).

The reference sign 8 indicates a third radiation device which also radiates radiation and in particular light along a beam path S3 onto the surface 10.

In an embodiment, a control device (not shown) is provided which activates the radiation devices 2, 6 and 8 with a time delay.

FIG. 2 shows a characteristic of an image recording device depending on the wavelength of the incoming radiation. More precisely, the sensitivity of the RGB filters of this image recording device or camera is shown.

Three curves R, G, B are shown, which refer to the “red”, “green” and “blue” components. The quantum efficiency in % is plotted on the coordinate and the wavelength of the incoming light on the ordinate.

It can be seen that the quantum efficiency of the camera as a whole first increases in the wavelength range between 400 nm and 800 nm and then decreases. In this way, the image recording device has its own characteristic of image reproduction or image recording.

FIG. 3 shows a representation of the tristimulus functions of the human eye. Here, too, three curves x(λ), y(λ) and z(λ) are shown, wherein the wavelength in nm is recorded on the ordinate and the tristimulus value on the coordinate.

A comparison of the illustrations in FIGS. 2 and 3 shows that the wavelength-dependent sensitivity curve of the image recording device and that of the human eye differ considerably. These differences are to be at least partially compensated for by embodiments of the invention.

FIG. 4 shows an illustration of an intensity course of a D65 standard light source in a range between 300 nm and 800 nm. This type of light is approximated to the course for daylight and cloudy skies. The second curve A shows the course of a conventional incandescent lamp.

Standard illuminant D represents the daylight spectrum and is therefore of particular interest for numerous industrial areas. The illuminant D65 derives its name from the color temperature of 6,504 Kelvin (K). D65 is used in the chemical and pharmaceutical industries, in paint production, in the ceramics, fabric, paper and automotive industries. 100881

The standard illuminant D65 has a high blue component with which fluorescent colors can be recognized.

D65 is used as an evaluation light source. The spectral distribution of D65 light sources is defined in DIN 5033 and lies between wavelengths of 300 nm and 780 nm, thus between ultraviolet and red.

FIG. 5 shows an emission spectrum of a light source is used in the context of embodiments of the invention, namely a tri-phosphor high CRI LED. It can be seen that this light source essentially radiates between 400 and 800 nm. Thereby, the relative radiation intensity, which is plotted on the coordinate between 400 nm, is substantially above 50%. The color temperature here is 5600 K. This radiation characteristic is also taken into account in the design of the filter device.

The abbreviation CRI stands for color rendering index. The color rendering index is a quantitative measure of a light source and describes the ability to render colors of objects compared to an ideal or natural light source. The term CRI is often used on commercial lighting products. Properly defined, it should be called Ra—general color rendering index—or Ri—special color rendering index—according to the test color samples being evaluated.

The CRI is calculated by comparing the color rendering of the test light source with that of a defined light source. For test light sources below 5000 K, a black-body spotlight is used as a defined comparison source. Daylight (D-lamp) is used for comparison for test light sources above 5000 K. The calculation of Ri and Ra is explained in detail in the CIE technical report 13.3-1995. The test method uses a set of eight Ra or 14 Ri CIE-1974 color samples from an early edition of the Munsell color system. The first eight samples are moderately saturated, encompass the color circle and have approximately equal brightness. The remaining six samples provide additional information about the color rendering properties of the light source.

FIG. 6 shows a transmission course of a filter device adapted for embodiments of the present invention, as calculated from the data described above and the equation shown above. Based on this data, a filter device is manufactured which shows approximately the transmission behavior shown in FIG. 6. In the manufacture of filter devices, there are several methods for achieving a desired transmission course, which have been explained above.

FIGS. 7a-7c show three representations of gradients (plotted in arbitrary units on the coordinate). FIG. 7b again shows the course of the human eye, which is also shown in FIG. 3. FIG. 7c shows the course that results from an image recording device without the filter device proposed in accordance with embodiments of the invention. FIG. 7a shows a sensitivity or a course which results when the filter device is used. It can be seen that the course shown in FIG. 7a is much closer to the “natural” course shown in FIG. 7b than the course shown in FIG. 7c.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps of elements. The mention of a “unit” or a “module” does not preclude the use of more than one unit or module.

1. A method for inspecting surfaces, wherein radiation is irradiated by a first radiation device onto a surface to be inspected at a first predetermined radiation angle and wherein a color image recording device records a spatially resolved image of the surface irradiated by the radiation direction at a first observation angle, wherein this image recording device has a first predetermined sensitivity which is dependent on a wavelength of the radiation impinging on the image recording device and which is differs from a second predetermined sensitivity which is dependent on a wavelength of the radiation impinging on the human eye, wherein differences between the first sensitivity and the second sensitivity are at least partially compensated for by a filter device.

2. The method according to claim 1, wherein the filter device is arranged between the surface and the image recording device.

3. The method according to claim 1, wherein the filter device influences the evaluation of the image recorded up by the image recording device.

4. The method according to claim 1, wherein the filter device has, in a wavelength range of 200 nm-1000 nm, a transmission which changes in this wavelength range as a function of the wavelength.

5. The method according to claim 4, wherein this changing transmission is chosen in such a way that it at least temporarily compensates for the wavelength-dependent differences between the first sensitivity and the second sensitivity.

6. The method according to claim 1, wherein by means of a refractive optical element, which is arranged between the surface and the filter device, the radiation impinging on the filter device is influenced and refracted.

7. The method according to claim 1, wherein radiation is irradiated onto the surface by a second radiation device at a second predetermined radiation angle and the image recording device records an image of the surface irradiated by the second radiation device.

8. The method according to claim 1, wherein the filter device takes into account an emission spectrum L(λ) of the radiation device, an intensity course I(λ) of a standard light, at least one tristimulus function X(λ), of the human eye, and/or one for a filter characteristic F(λ) of the image recording device.

9. The method according to claim 1, wherein the observation angle with respect to a direction perpendicular to the surface is smaller than 10°, smaller than 5°, smaller than 3°, and/or in that the first angle of incidence with respect to a direction perpendicular to the surface is between 70° and 20°, between 60° and 30°, between 50° and 40°.

10. The method according to claim 1, wherein at least one radiation device directs directed or diffuse radiation onto the surface.

11. An apparatus for inspecting surfaces having a first radiation device which irradiates radiation onto a surface to be inspected at a first predetermined radiation angle and having a color image recording device which records a spatially resolved image of the surface irradiated by the radiation direction at a first observation angle, wherein this image recording device having a first predetermined sensitivity which is dependent on a wavelength of the radiation impinging on the image recording device and which differs from a second predetermined sensitivity which is dependent on a wavelength of the radiation incident on the human eye, wherein the apparatus has a filter device which at least partially compensates for differences between the first sensitivity and the second sensitivity.

12. The apparatus according to claim 11, wherein the filter device is arranged in a beam path between the surface and the image recording device.

13. The apparatus according to claim 1, wherein a refractive element and a lens is arranged between the surface and the filter device.

14. The apparatus according to claim 1, wherein the first radiation device comprises a light-emitting diode and a tri-phosphor LED.

15. The apparatus according to claim 1, wherein the apparatus comprises at least one second radiation device and/or a second sensor device.

16. The method for inspecting surfaces of claim 1, wherein the surfaces are surfaces of motor vehicles having effect pigments.

17. The apparatus for inspecting surfaces of claim 11, wherein the surfaces are surfaces of motor vehicles having effect pigments.
